(19) United States
(12) Patent Application Publication
(10) Pub. No.: US 2026/0201121 A1
(43) Pub. Date: Jul. 16, 2026

(54) UV CURABLE SILICONE COMPOSITION

(71) Applicant: DOW SILICONES CORPORATION, Midland, MI (US)

(72) Inventors: Chungeun LEE, Chungcheongbuk-do (KR); Minhee KWON, Chungcheongbuk-Do (KR); Jongchan PARK, Chungcheongbuk-Do (KR)

(21) Appl. No.: 19/135,401

(22) PCT Filed: Dec. 1, 2023
(86) PCT No.: PCT/US2023/082015

§ 371 Date: Jun. 4, 2025

Related U.S. Application Data
(60) Provisional application No. 63/430,167, filed on Dec. 5, 2022.

(51) Int. Cl. C08G 77/20; C08G 77/00; C08G 77/12; C08K 3/36

(52) U.S. Cl. CPC C08G 77/20; C08G 77/12; C08K 3/36; C08G 77/80

(57) ABSTRACT

Disclosed is a UV curable silicone composition comprising: (A) a branched organopolysiloxane having at least one alkenyl group with 2 to 12 carbon atoms (C2-C12) and at least one aryl group with 6 to 12 carbon atoms (C6-C12) per molecule; (B) a linear organopolysiloxane having at least two C2-C12 alkenyl groups and at least one C6-C12 aryl group per molecule; (C) an organosiloxane having at least two silicon-bonded hydrogen atoms and at least one C6-C12 aryl group per molecule; and (D) a photoactivated hydrosilylation reaction catalyst. A content of total aryl groups in components (A) to (C) is at least 35 mass % of a total mass of components (A) to (C). The composition has a good pot-life, and cures to form a B-stage material by irradiating with an ultraviolet light. The B-stage material exhibits a slow gel-time, but can fully cure at a low temperature, e.g., 75° C. or below.

### CROSS-REFERENCE TO RELATED APPLICATIONS

The application claims priority to and all advantages of U.S. Provisional Patent Application No. 63/430,167 filed on 5 Dec. 2022, the content of which is incorporated herein by reference.

### TECHNICAL FIELD

The present invention relates to a UV curable silicone composition.

### BACKGROUND ART

UV curable silicone compositions, when irradiated with an ultraviolet light, cure to form cured products having excellent heat resistance, electrical insulating properties and weatherability. Therefore, the UV curable silicone compositions are widely used as protective coating agents, encapsulants or sealants of electric/electronic equipment.

For example, Patent Document 1 discloses a UV curable silicone composition comprising: an organopolysiloxane having on average at least two silicon-bonded alkenyl groups per molecule, an organosilicon compound having on average at least two silicon-bonded hydrogen atoms per molecule, and a photoactivated hydrosilylation catalyst; Patent Document 2 discloses a UV curable silicone composition comprising: a branched organopolysiloxane having a vinyl group or an allyl group, and having continuously repeated D siloxane units of 5 to 300, an organohydrogenpolysiloxane having a resin structure and having continuously repeated D siloxane units of 5 to 300, and a photoactive catalyst; Patent Document 3 discloses a UV curable silicone composition comprising: an organosilicon compound having on average at least two silicon-bonded ethylenically unsaturated groups and at least one silicon-bonded phenyl group per molecule, an organosilicon compound having on average at least two silicon-bonded hydrogen atoms per molecule, and a photoactivated hydrosilylation catalyst, and optionally, a filler; Patent Document 4 discloses a UV curable silicone composition comprising: a linear organopolysiloxane having two alkenyl groups and at least two aryl groups per molecule, an organohydrogenpolysiloxane having at least two silicon-bonded hydrogen atoms per molecule, a platinum metal catalyst that is activated by light having a wavelength of between 200 and 500 nm, and a compound having one terminal alkenyl group per molecule; and Patent Document 5 discloses a UV curable silicone composition comprising: a compound containing at least one aliphatically unsaturated monovalent hydrocarbon group in the molecule, a compound containing at least two hydrogen atoms bonded to silicon atoms in the molecule, a first hydrosilylation catalyst exhibiting activity in the composition without exposure to high energy radiation, and a second hydrosilylation catalyst not exhibiting activity unless exposed to high energy radiation, and exhibiting activity in the composition by exposure to high energy radiation.

Recently, UV curable silicone compositions are required to initiate by UV light and keep in the room temperature for several hours waiting for next process with non-flowable state. A material with non-flowable state, namely “B-stage like,” needs to be maintained in gel state after UV irradiation during working (or process) time. Furthermore, the UV curable silicone compositions need to be ease of use, like a 1-part composition, and preferably cure first at low-temperature e.g., 75° C. or below within 30 mins to achieve a good processability and less module damages from high temperature. Lastly, fully cured silicone material is preferable obtaining good hardness since soft material cannot protect the circuit on plastics and maintain the bending shape.

However, these UV curable silicone compositions mentioned above have several problems, for example, a short pot-life, and increasing their viscosity dramatically at RT condition and too fast curing after UV irradiation. Moreover, they could not fully cure at 75° C. within 30 mins.

### PRIOR ART DOCUMENTS

### Patent Documents

Patent Document 1: U.S. Patent Application Publication No. 2003/0235383 A1
Patent Document 2: U.S. Patent Application Publication No. 2013/0183776 A1
Patent Document 3: U.S. Patent Application Publication No. 2017/0283655 A1
Patent Document 4: European Patent Application Publication No. 3 862 405 A1
Patent Document 5: U.S. Patent Application Publication No. 2021/0179849 A1

### SUMMARY OF INVENTION

### Technical Problem

An object of the present invention is to provide a UV curable silicone composition with a good pot-life, and cures to form a B-stage material by irradiating with an ultraviolet light, wherein the B-stage material exhibits a slow gel-time, however, can fully cure at a low temperature, e.g., 75° C. or below.

### Solution to Problem

The UV curable silicone composition of the present invention comprises:
(A) a branched organopolysiloxane having at least one alkenyl group with 2 to 12 carbon atoms and at least one aryl group with 6 to 12 carbon atoms per molecule;
(B) a linear organopolysiloxane having at least two alkenyl groups with 2 to 12 carbon atoms and at least one aryl group with 6 to 12 carbon atoms per molecule;
(C) an organosiloxane having at least two silicon-bonded hydrogen atoms and at least one aryl group with 6 to 12 carbon atoms per molecule, in an amount such that silicon-bonded hydrogen atoms in component (C) is 0.1 to 10 moles relative to 1 mole of alkenyl groups in components (A) and (B); and
(D) a catalytic amount of a photoactivated hydrosilylation reaction catalyst;
(E) wherein a content of total aryl groups in components (A) to (C) is at least 35 mass % of a total mass of components (A) to (C).

In various embodiments, component (A) is a branched organopolysiloxane represented by the following average unit formula:

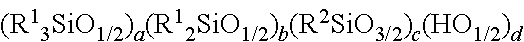

wherein each R¹ is independently an alkyl group with 1 to 12 carbon atoms, alkenyl group with 2 to 12 carbon atoms, or an aryl group with 6 to 12 carbon atoms, with the proviso that at least one R¹ in a molecule being an alkenyl group; R² is an alkyl group with 1 to 12 carbon atoms or an aryl group with 6 to 12 carbon atoms, with the proviso that at least one R² in a molecule being an aryl group; and “a”, “b”, “c” and “d” are numbers satisfying the following conditions: 0<a≤0.3, 0≤b≤0.2, 0.5≤c≤0.9, 0≤d≤0.05, and a+b+c=1.

In various embodiments, component (B) is a linear organopolysiloxane represented by the following general formula:

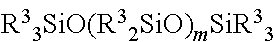

wherein each R³ is independently an alkyl group with 1 to 12 carbon atoms, alkenyl group with 2 to 12 carbon atoms, or an aryl group with 6 to 12 carbon atoms, with the proviso that at least two R³ in a molecule being alkenyl groups and at least one R³ in a molecule being an aryl group; and “m” is an integer of from 10 to 1,000.

In various embodiments, component (C) is an organosiloxane represented by the following general formula:

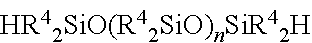

wherein each R⁴ is independently an alkyl group or an aryl group, with the proviso that at least one R⁴ is an aryl group; and “n” is an integer of 0 to 10.

In various embodiments, the composition further comprises: (E) a hydrosilylation reaction inhibitor, in an amount of 0.1 to 10,000 ppm in this component in terms of mass units with respect to a total mass of components (A) to (C).

In various embodiments, the composition further comprises: (F) an adhesion promotor, in an amount of at most 10 parts by mass relative to 100 parts by mass of a total mass of components (A) to (C).

In various embodiments, the composition further comprises: (G) a silica filler, in an amount of 0.1 to 10 parts by mass relative to 100 parts by mass of a total mass of components (A) to (C).

### Effects of Invention

The UV curable silicone composition of the present invention has a good pot-life, and cures to form a B-stage material by irradiating with an ultraviolet light, wherein the B-stage material exhibits a slow gel-time, however, can fully cure at a low temperature, e.g., 75° C. or below.

### Definitions

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The term “B-stage state” refers to a state of a cured intermediate product of the UV curable silicone composition, wherein, when the UV curable silicone composition is incompletely cured, it swells due to a solvent, but is not completely dissolved. While “B-stage product” enters a completely cured to form “C-stage product.”

### DETAILED DESCRIPTION OF THE INVENTION

The UV curable silicone composition of the present invention will be explained in detail.

Component (A) is a branched organopolysiloxane having at least one alkenyl group with 2 to 12 carbon atoms and at least one aryl group with 6 to 12 carbon atoms per molecule. Examples of the alkenyl groups include vinyl groups, allyl groups, butenyl groups, pentenyl groups, hexenyl groups, heptenyl groups, octenyl groups, nonenyl groups, decenyl groups, undecenyl groups, and dodecenyl groups, among which vinyl groups are preferable. Examples of the aryl groups include phenyl groups, tolyl groups, xylyl groups, and naphthyl groups, among which phenyl groups are preferable. In addition, examples of groups bonding to silicon atoms other than alkenyl groups and aryl groups in component (A) include alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups, and dodecyl groups; aralkyl groups with 7 to 20 carbon atoms such as benzyl groups, phenethyl groups, and phenylpropyl groups; and groups in which some or all of the hydrogen atoms of these groups are substituted with halogen atoms such as fluorine atoms, chlorine atoms, or bromine atoms. Furthermore, the silicon atoms in component (A) may have small amounts of hydroxyl groups or alkoxy groups such as methoxy groups or ethoxy groups within a range that does not impair the object of the present invention.

Component (A) is typically a branched organopolysiloxane represented by the following average unit formula:

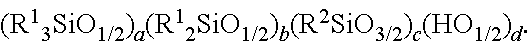

In the formula above, each R¹ is independently an alkyl group with 1 to 12 carbon atoms, alkenyl group with 2 to 12 carbon atoms, or an aryl group with 6 to 12 carbon atoms, and examples thereof include the same groups as described above. However, at least one R¹ in a molecule is an alkenyl group, preferably a vinyl group.

In the formula above, R² is an alkyl group with 1 to 12 carbon atoms or an aryl group with 6 to 12 carbon atoms, and examples thereof include the same groups as described above. However, at least one R² in a molecule is an aryl group, preferably a phenyl group.

In the formula above, “a”, “b”, “c” and “d” are numbers satisfying the following conditions: 0<a≤0.3, 0≤b≤0.2, 0.5≤c≤0.9, 0≤d≤0.05, and a+b+c=1, optionally 0.1≤a≤0.5, b=0, 0.5≤c≤0.9, 0≤d≤0.05, and a+b+c=1, or optionally 0.1≤a≤0.3, b=0, 0.7≤c≤0.9, 0≤d≤0.05, and a+b+c=1. This is because, if “a”, “b”, “c” and “d” are numbers within the ranges mentioned above, a cured product obtained by curing the present composition will have appropriate hardness and mechanical strength.

An amount of component (A) is not limited, but it is typically used in an amount of from 60 to 90 mass %, optionally in an amount of from 65 to 90 mass %, optionally in an amount of from 60 to 85 mass %, or optionally in an amount of from 65 to 85 mass %, each based on a total mass of components (A) to (C). This is because, if the amount is equal to or above the lower limit of the ranges described above, a cured product obtained by curing the present composition will have appropriate hardness and mechanical strength, whereas the amount is equal to or below the upper limit of the ranges described above, the composition has suitable viscosity at 25° C.

Component (B) is a linear organopolysiloxane having at least two alkenyl groups with 2 to 12 carbon atoms and at least one aryl group with 6 to 12 carbon atoms per molecule. Component (B) is used to impart a cured product obtained by curing the composition with a good modulus. Examples of the alkenyl groups include the same groups as described above. Examples of the aryl groups include the same groups as described above. In addition, examples of groups bonding to silicon atoms other than alkenyl groups and aryl groups in component (B) include the same groups as described above. Furthermore, the silicon atoms in component (B) may have small amounts of hydroxyl groups or alkoxy groups such as methoxy groups or ethoxy groups within a range that does not impair the object of the present invention.

A viscosity at 25° C. of component (B) is not limited, but is typically not more than 100,000 mPa·s, optionally not more than 50,000 mPa·s, or optionally not more than 20,000 mPa·s. Note that in the present specification, viscosity is the value measured using a type B viscometer according to ASTM D 1084 at 23±2° C.

Component (B) is typically a linear organopolysiloxane represented by the following general formula:

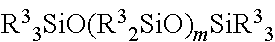

In the formula above, each R³ is independently an alkyl group with 1 to 12 carbon atoms, alkenyl group with 2 to 12 carbon atoms, or an aryl group with 6 to 12 carbon atoms, and examples thereof include the same groups as R¹ described above. However, at least two R³ in a molecule are alkenyl groups and at least one R³ in a molecule is an aryl group, typically at least two R³ in a molecule are vinyl groups and at least one R³ in a molecule is a phenyl group.

In the formula above, “m” is an integer of from 10 to 1,000, optionally an integer of from 10 to 500.

Component (B) is typically at least one selected from organopolysiloxanes represented by the following formulae:

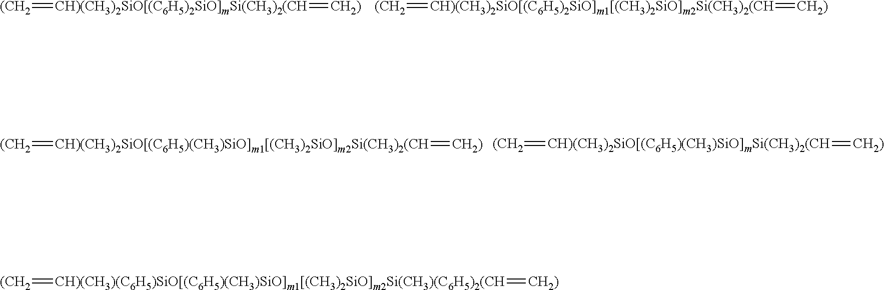

In the formulae above, “m” is as described above, and “m2” is an integer each “m1” and “m2” is an integer satisfying: 10≤(m1+m2)≤1,000, optionally 10≤(m1+m2)≤500.

An amount of component (B) is not limited, but it is typically used in an amount of from 1 to 20 mass %, optionally in an amount of from 1 to 15 mass %, or optionally in an amount of from 5 to 20 mass %, each based on a total mass of components (A) to (C). This is because, if the amount is equal to or above the lower limit of the ranges described above, the composition has a good modulus, whereas the amount is equal to or below the upper limit of the ranges described above, the obtained cured product has good mechanical properties.

Component (C) is an organosiloxane having at least two silicon-bonded hydrogen atoms and at least one aryl group with 6 to 12 carbon atoms per molecule, and is used as a crosslinking agent for the composition. Examples of groups bonding to silicon atoms other than hydrogen atoms include alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups, and dodecyl groups; aryl groups with 6 to 12 carbon atoms such as phenyl groups, tolyl groups, xylyl groups, and naphthyl groups; aralkyl groups with 7 to 20 carbon atoms such as benzyl groups, phenethyl groups, and phenylpropyl groups; and groups in which some or all of the hydrogen atoms of these groups are substituted with halogen atoms such as fluorine atoms, chlorine atoms, or bromine atoms. However, at least one silicon-bonded organic group in a molecule is an aryl group, preferably a phenyl group. Furthermore, the silicon atoms in component (C) may have small amounts of hydroxyl groups or alkoxy groups such as methoxy groups or ethoxy groups within a range that does not impair the object of the present invention.

A viscosity at 25° C. of component (C) is not limited, but is typically not more than 1,000 mPa·s, optionally not more than 500 mPa·s, or optionally not more than 100 mPa·s. Note that in the present specification, viscosity is the value measured using a type B viscometer according to ASTM D 1084 at 23±2° C.

The organosiloxane for component (C) is typically an organosiloxane oligomer represented by the following general formula:

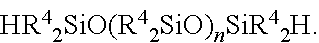

In the formula above, each R⁴ is an alkyl group with 1 to 12 carbon atoms or an aryl group with 6 to 12 carbon atoms, and examples thereof include the same groups as R² described above. However, at least one R⁴ is an aryl group, typically a phenyl group.

In the formula, “n” is an integer of 0 to 10, optionally an integer of 0 to 5, optionally an integer of 0 to 3, or optionally an integer of 0 or 1.

Component (C) is typically at least one selected from organosiloxane oligomers represented by the following formulae:

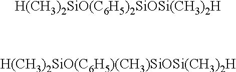

Component (C) is used in an amount such that silicon-bonded hydrogen atoms in component (C) is 0.1 to 10 moles, optionally in a range of from 0.5 to 1.5, or optionally in a range of from 0.8 to 1.5, each relative to 1 mole of alkenyl groups in components (A) and (B). This is because, if the molar ration is equal to or above the lower limit of the ranges described above, the composition can be fully cured, and a cured product obtained by curing the present composition will have appropriate hardness and mechanical strength, whereas the molar ratio is equal to or below the upper limit of the ranges described above, the cured product has good thermal stability.

The content of total aryl groups in components (A) to (C) is at least 35 mass % of a total mass of components (A) to (C). In various embodiments, the content of total aryl groups in components (A) to (C) is at least 40 mass %, optionally at least 45 mass %, or optionally at least 50 mass %, of a total mass of components (A) to (C). In further or other embodiments, the content of total aryl groups in components (A) to (C) is at most 80 mass %, optionally at most 75 mass %, or optionally at most 70 mass %, of a total mass of components (A) to (C).

Component (D) is a photoactivated hydrosilylation reaction catalyst which is activated by UV light. That is, it is a catalyst that is inactive in the absence of UV light but, when irradiated with UV light, changes to a hydrosilylation reaction catalyst which is active at room temperature, promoting hydrosilylation reactions between the alkenyl groups in components (A) and (B) and the silicon-bonded hydrogen atoms in component (C).

Examples of photoactivated hydrosilylation reaction catalysts for component (D) include cyclopentadienyl platinum compounds and derivatives thereof such as trimethyl (methylcyclopentadienyl) platinum (IV), trimethyl (cyclopentadienyl) platinum (IV), trimethyl (1,2,3,4,5-pentamethylcyclopentadienyl) platinum (IV), dimethylethyl (cyclopentadienyl) platinum (IV), dimethylacetyl (cyclopentadienyl) platinum (IV), trimethyl (trimethylsilylcyclopentadienyl) platinum (IV), trimethyl (methoxycarbonylcyclopentadienyl) platinum (IV) and trimethyl (dimethylphenylsilyl cyclopentadienyl) cyclopentadienyl platinum (IV). Of these, trimethyl cyclopentadienyl platinum, trimethyl (methylcyclopentadienyl) platinum and derivatives of these in which the cyclopentadienyl group has been modified are especially preferred.

β-diketonato platinum compounds are also preferred examples of component (D). Examples of β-diketonato platinum compounds for component (D) include trimethyl (acetylacetonato) platinum (IV), trimethyl (3,5-heptanedionate) platinum (IV), trimethyl (methyl acetoacetate) platinum (IV), bis(acetylacetonato) platinum (II), bis(2,4-pentanedionato) platinum (II), bis(2,4-hexanedionato) platinum (II), bis(2,4-heptandionato) platinum (II), bis(3,5-heptanedionato) platinum (II), bis(1-phenyl-1,3-butanedionato) platinum (II), bis(1,3-diphenyl-1,3-propanedionato) platinum (II), and bis(hexafluoroacetylacetonato) platinum (II). Of these, bis(acetylacetonato) platinum compounds and derivatives in which the acetylacetonato groups have been modified are especially preferred.

Component (D) is used in an effective quantity for facilitating curing of the present composition. Specifically, in order to satisfactorily cure the present composition, the content of component (D) is typically a quantity whereby the content of catalytic metal in component (D) relative to the present composition is in a range of from about 0.01 to about 500 ppm, optionally in a range of from about 0.01 to about 250 ppm, optionally in a range of from about 0.01 to about 200 ppm, or optionally in a range of from about 0.1 to about 100 ppm, in terms of mass units.

In various embodiments, the curable silicone composition comprises (E) a hydrosilylation reaction inhibitor in order to adjust the cure rate of the curable silicone composition. In certain embodiments, component (F) includes, without limitation, an alkyne alcohol such as 2-methyl-3-butyn-2-ol, 3,5-dimethyl-1-hexyn-3-ol, or 2-phenyl-3-butyn-2-ol, 1-ethynyl-cyclohexan-1-ol; an ene-yne compound such as 3-methyl-3-penten-1-yne or 3,5-dimethyl-3-hexen-1-yne; or 1,3,5,7-tetramethyl-1,3,5,7-tetravinylcyclotetrasiloxane, 1,3,5,7-tetramethyl-1,3,5,7-tetrahexenylcyclotetrasiloxane, tris[(1,1-dimethyl-2-propynyl)oxy]methylsilane, diallyl maleate or a benzotriazole may be incorporated as an optional component in the present composition.

An amount of component (E) in the present composition is not particularly limited, but if included is typically in an amount of from about 1 to about 10,000 ppm, optionally an amount of from about 10 to about 5,000 ppm in this component in terms of mass units with respect to a total mass of components (A) to (C). This is because when the amount of component (E) is greater than or equal to the lower limit of the aforementioned range, storage stability of the composition is good, whereas when the amount of component (E) is less than or equal to the upper limit of the aforementioned range, curability of the composition at low temperatures is good.

In order to improve adhesion of the cured product to a base material being contacted during curing, the present composition may contain (F) an adhesion promotor. In certain embodiments, the adhesion promotor for component (F) is typically an organosilicon compound having at least one alkoxy group bonded to a silicon atom in a molecule. This alkoxy group is exemplified by a methoxy group, an ethoxy group, a propoxy group, a butoxy group, and a methoxyethoxy group; and the methoxy group is most typical. Moreover, non-alkoxy groups bonded to a silicon atom of this organosilicon compound are exemplified by substituted or non-substituted monovalent hydrocarbon groups such as alkyl groups, alkenyl groups, aryl groups, aralkyl groups, halogenated alkyl groups and the like; epoxy group-containing monovalent organic groups such as a 3-glycidoxypropyl group, a 4-glycidoxybutyl group, or similar glycidoxyalkyl groups; a 2-(3,4-epoxycyclohexyl)ethyl group, a 3-(3,4-epoxycyclohexyl)propyl group, or similar epoxycyclohexylalkyl groups; and a 4-oxiranylbutyl group, an 8-oxiranyloctyl group, or similar oxiranylalkyl groups; acrylic group-containing monovalent organic groups such as a 3-methacryloxypropyl group and the like; and a hydrogen atom. This organosilicon compound generally has a silicon-bonded alkenyl group or silicon-bonded hydrogen atom. Moreover, due to the ability to impart good adhesion with respect to various types of base materials, this organosilicon compound generally has at least one epoxy group-containing monovalent organic group in a molecule. This type of organosilicon compound is exemplified by organosilane compounds, organosiloxane oligomers and alkyl silicates. Molecular structure of the organosiloxane oligomer or alkyl silicate is exemplified by a linear chain structure, partially branched linear chain structure, branched chain structure, ring-shaped structure, and net-shaped structure. A linear chain structure, branched chain structure, and net-shaped structure are typical. This type of organosilicon compound is exemplified by silane compounds such as 3-glycidoxypropyltrimethoxysilane, 2-(3,4-epoxycyclohexyl)ethyltrimethoxysilane, 3-methacryloxy propyltrimethoxysilane, and the like; siloxane compounds having at least one silicon-bonded alkenyl group or silicon-bonded hydrogen atom, and at least one silicon-bonded alkoxy group in a molecule; mixtures of a silane compound or siloxane compound having at least one silicon-bonded alkoxy group and a siloxane compound having at least one silicon-bonded hydroxyl group and at least one silicon-bonded alkenyl group in the molecule; and methyl polysilicate, ethyl polysilicate, and epoxy group-containing ethyl polysilicate.

In the present composition, an amount of component (F) is not particularly limited, but in order to achieve good adhesion to a base material being contacted during curing, it is typically at most 10 parts by mass relative to 100 parts by mass of a total mass of components (A) to (C).

In order to improve mechanical properties of the cured product, the present composition may contain (G) a silica filler. Component (G) is typically fumed or precipitated silica filler having a BET surface area of at least 50 m²/g, optionally 80 to 400 m²/g, or optionally 100 to 400 m²/g. A surface of the silica filer may be un-treated or treated with treating agents such as organochlorosilanes, organoalkoxysilanes, organosilazanes, and organosiloxane oligomers.

The silica filler for component (G) is commercially available. Examples of the silica fillers include fumed silica from Degussa Corporation under the tradename AEROSIL™, such as AEROSIL™ R8200, R9200, R812, R812S, R972, R974, R805, R202; fumed silica from Cabot Corporation under the tradename CAB-O-SIL™ ND-TS, TS610 or TS710; and fumed silica from Tokuyama Corporation under the tradename REOLOSIL™, such as DM-10, DM-20S, DM-30, HM-30S, MT-10, PM-20L, QS-10, QS-20A, and QS-25C.

An amount of component (G) is in a range of from 1 to 10 parts by mass, optionally in a range of from 1 to 5 parts relative to 100 parts by mass of a total mass of components (A) to (C). This is because, if the amount of component (G) is equal to or above the lower limit of the ranges described above, the cured product obtained by curing the present composition has appropriate hardness and mechanical strength, whereas the amount is equal to or below the upper limit of the ranges described above, the present composition a has good transparency.

A refractive index at 25° C. of the present composition is not limited, but it is typically in a range from 1.50 to 1.60. While, a viscosity at 25° C. of the present composition is not limited, but it is typically in a range of from 1 to 100 Pa·s, optionally in a range of from 1 to 50 Pa·s, or optionally in a range of from 1 to 20 Pa·s, as measured at shear rate of 1/s.

### EXAMPLES

The UV curable silicone composition of the present invention will be described in detail hereinafter using Practical Examples and Comparative Examples. However, the present invention is not limited by the description of the below listed Examples.

### [Refractive Index]

A refractive index at 25° C. of the UV curable silicone composition was measured by means of an abbe refractometer produced by ATAGO Co., Ltd. at a wavelength of 589 nm under atmospheric pressure of 1013 mbar in accordance with the standard DIN 51423.

### [Viscosity]

Viscosities (mPa·s or Pa·s) for all samples were measured using Brookfield cone and plate viscometer (HADV-III U) with the cone spindle CP-52. Measuring temperature is 25±2° C. and sample were measured with a speed that torque had between 50~70%.

### [Shelf Stability]

UV curable silicone compositions were stored at room temperature 25±2° C. for 5 days and measuring viscosity after 5 days. Viscosity increase must not be over 10% from the initial viscosity.

### [Low Temperature Cure]

After UV irradiation, all samples were cured in the oven set at 70° C. for 30 mins.

### [Shore D Hardness]

Hardness is measured by durometer (shore D) and cured samples were prepared by the thickness over 6 mm and surface of cured sample was made as flat as possible to reduce variances. Hardness was measured at least 3 points of the flat surface and used the average hardness value.

[Gel-Time after UV Exposure]

Gel-time is measured after UV exposure with 365 nm and energy 5,000 mJ/cm² dosage of UVA. UV exposed samples were left at room temperature for over 4 hrs. and then viscosities were measured with the same manner of viscosity assessment. In the case of samples reached gel-time in the designated time, the results were recorded as “gel” or “cured”.

### [Cure Rate]

Cure rate was measured by using FT-IR (Nicolet Is50 FTIR) and intensity of Si—H (2,100 cm¹). Silicone compositions are coated on slid glass with using punched mask (10 mm×30 mm×0.5 mmT) and then prepared samples are exposed in UV light (LED 365 nm, 5,000 mJ/cm² UVA dose). UV exposed samples were put in the oven set 70° C. for 30 mins. Cure rate is measured with relative comparison methods between none-cured sample and fully cured sample and calculated the rate reducing Si—H intensity. Fully cured samples were prepared with the same manner as other sample except post-cure temperature, 120° C. for 30 mins.

Cured samples were measured by FT-IR and assessment mode was single-bounce ATR. Samples were placed on the Diamond detector with pressure clamp to be tightly pressed and then intensity of Si—H was measured. Cure rate was calculated with the height of peak and calculation formula is as follows. Height was revised to make correct by selected reference peak that was the most constant peak of all samples.

$$Reaction rate ( \% ) = [ ( {H}_{0 \%} - {H}_{sample} ) / ( {H}_{0 \%} - {H}_{100 \%} ) ] \times 100$$

$${H}_{( X = 0 \% , sample , 100 \% )} = {H}_{@ SiH} / {H}_{@ Ref}$$

H_{0%}: Peak height of liquid before UV curing (Reaction rate=0%)
Hₛₐₘₚₗₑ: Peak height of sample after UV curing
H_{100%}: Standard Peak height of full cured sample (Reaction rate=100%)

### Examples 1-4 and Comparative Examples 1-5

The following components were mixed to uniformity in the quantity proportions shown in Table 1 to produce UV curable silicone compositions. The compositions were prepared as follows.

Components (A), (B), (C), (E) and (G) were mixed at 1,500 rpm for 2 mins. Then component (F) was added to a mixture prepared above and mixed at 2,000 rpm for 2 mins. for twice to be well dispersed. Finally, component (D) was added to a mixture prepared above and mixed at 1,500 rpm for 2 mins. Obtained ultraviolet ray-curable silicone compositions were packaged in 30 mL syringes and vacuum sealed. These samples were stored in aluminum bag at −5° C. to avoid light and for long shelf life. Essential properties (viscosity, cure rate, etc.) were measured and then samples were stored in RT for shelf-life study. These results are given in Table 1. The “SiH/Vi ratio” in Table 1 indicates a molar ratio of all silicon atom-bonded hydrogen atoms in component (C) relative to all silicon atom-bonded vinyl groups in components (A) and (B).

The following branched organopolysiloxanes were used as component (A).
(a1): a branched organopolysiloxane represented by the following average unit formula:

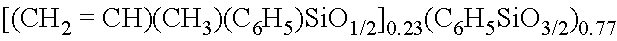

having a vinyl group content of 4.60 mass % and a phenyl group content of 57.03 mass %. (a2): a branched organopolysiloxane represented by the following average unit formula:

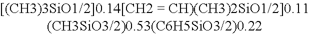

having a vinyl group content of about 3.47 mass % and a phenyl group content of 19.81 mass %.

The following branched organopolysiloxane was used as comparison of component (A).
(a3): an organopolysiloxane resin represented by the following average unit formula:

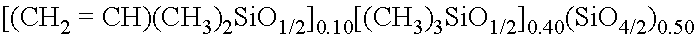

having a vinyl group content of 3.76 mass %.

The following linear organopolysiloxanes were used as component (B).
(b1): a methylphenylpolysiloxane represented by the following formula:

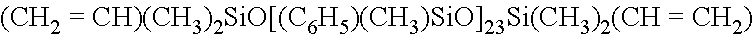

having a vinyl group content of about 1.63 mass % and a phenyl group content of 53.42 mass %, and having a viscosity of 2,700 mPa·s.
(b2): a copolymer of dimethylsiloxane and diphenylsiloxane represented by the following formula:

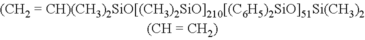

having a vinyl group content of 0.21 mass % and a phenyl group content of 30.40 mass %, and having a viscosity of 14,500 mPa·s.

The following organopolysiloxanes were used as comparison of component (B).
(b3): a dimethylpolysiloxane represented by the following formula:

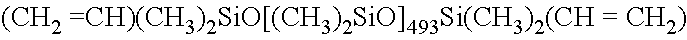

having a vinyl content of 0.15 mass %, and having a viscosity of 10,000 mPa·s.
(b4): a dimethylpolysiloxane represented by the following formula:

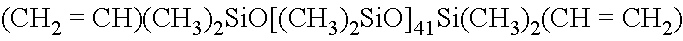

having a vinyl group content of 1.68 mass %, and having a viscosity of 60 mPa·s.

The following organopolysiloxane was used as component (C).
(c1): an organosiloxane represented by the following formula:

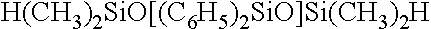

having a silicon atom-bonded hydrogen atom content of about 0.61 mass %, and having a viscosity of 4.4 mPa·s.

The following organopolysiloxane was used as comparison of component (C).
(c2): an organosiloxane represented by the following average unit formula:

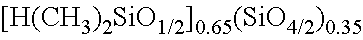

and having a silicon atom-bonded hydrogen atom content of about 0.99 mass %.

The following a photoactivated hydrosilylation reaction catalysts were used as component (D).
(d1): 1 mass %—a trimethyl (methylcyclopentadienyl) platinum (IV) of a methyl trimethoxysilane solution
(d2): 0.5 mass %—a bis(acetylacetonate) platinum (II) of a methyl trimethoxysilane solution

The following a hydrosilylation reaction catalyst was used as comparison of component (D).
(d3): 0.5 mass %—a platinum 1,3-divinyl-1,1,3,3-tetramethyldisiloxane complex of a methyl trimethoxysilane solution

The following hydrosilylation reaction inhibitors were used as component (E).
(e1): methyl-tris(1,1-dimethyl-2-propynyloxy) silane

The following fumed silica was used as component (F).
(f1): a fumed silica with a BET specific surface area of 230 m²/g (REOLOSIL DM-30S from TOKUYAMA Corporation)

The following adhesion promotor was used as component (G).
(g1): an organopolysiloxane represented by the following average unit formula:

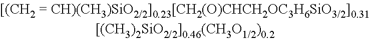

TABLE 1

Practical Examples

| | | | 1 | 2 | 3 | 4 |
|---|---|---|---|---|---|---|
| UV Curable | (A) | (a1) | 70.81 | 69.96 | 56.64 | 35.40 |
| Silicone | | (a2) | — | — | 15.54 | 38.84 |
| Composition | | (a3) | — | — | — | — |
| (parts by mass) | (B) | (b1) | 6.49 | 6.49 | 5.19 | 3.25 |
| | | (b2) | — | — | 1.20 | 3.00 |
| | | (b3) | — | — | — | — |
| | | (b4) | — | — | — | — |
| | (C) | (c1) | 18.16 | 17.96 | 17.04 | 14.98 |
| | | (c2) | — | — | — | — |
| | (D) | (d1) | 1.05 | — | 1.05 | 1.05 |
| | | (d2) | — | 2.10 | — | — |
| | | (d3) | — | — | — | — |
| | (E) | (e1) | 0.00008 | 0.0008 | 0.00019 | 0.00038 |
| | (F) | (f1) | 0.49 | 0.49 | 0.49 | 0.49 |
| | (G) | (g1) | 3.00 | 3.00 | 3.00 | 3.00 |

| | | | | |
|---|---|---|---|---|
| Phenyl Content (mass %) | 54.8 | 54.8 | 48.6 | 39.3 |
| SiH/Vi ratio | 0.9 | 0.9 | 0.9 | 0.8 |
| Refractive Index | 1.55 | 1.55 | 1.53 | 1.51 |
| Viscosity (Pa · s) | 10.0 | 10.7 | 10.4 | 11.7 |
| Shelf Stability (%) | 3 | 8 | 8 | 9 |
| Shore D Hardness | 73 | 73 | 58 | 45 |
| Cure Rate (%) | 96.9 | 95.9 | 94.9 | 94.0 |
| Gel-time After UV exposure, | gel | gel | gel | gel |
| Product state after 4 hrs. | | | | |
| Gel-time After UV exposure, | 44 | 43 | 48 | 47 |
| Cure Rate after 4 hrs. (%) | | | | |

| | | | Comparative Examples | | | | |
|---|---|---|---|---|---|---|---|
| | | | 1 | 2 | 3 | 4 | 5 |
| UV Curable | (A) | (a1) | 14.16 | — | — | 71.61 | 71.56 |
| Silicone | | (a2) | 62.14 | 77.67 | — | — | — |
| Composition | | (a3) | — | — | 65.81 | — | — |
| (parts by mass) | (B) | (b1) | 1.30 | — | — | 6.49 | 6.49 |
| | | (b2) | 4.79 | 5.99 | — | — | — |
| | | (b3) | — | — | 6.31 | — | — |
| | | (b4) | — | — | 16.45 | — | — |
| | (C) | (c1) | 13.07 | 11.80 | — | 18.37 | 18.36 |
| | | (c2) | — | | 6.69 | — | — |
| | (D) | (d1) | 1.05 | 1.05 | 1.05 | — | — |
| | | (d2) | — | — | — | — | — |
| | | (d3) | — | — | | 0.04 | 0.10 |
| | (E) | (e1) | 0.00056 | 0.0008 | 0.0001 | 0.00008 | 0.00008 |
| | (F) | (f1) | 0.49 | 0.49 | 0.49 | 0.49 | 0.49 |
| | (G) | (g1) | 3.00 | 3.00 | 3.00 | 3.00 | 3.00 |

| | | | | | |
|---|---|---|---|---|---|
| Phenyl Content (mass %) | 30.0 | 23.8 | 0 | 54.8 | 54.8 |
| SiH/Vi ratio | 0.8 | 0.7 | 0.7 | 0.9 | 0.9 |
| Refractive Index | 1.49 | 1.48 | 1.42 | 1.55 | 1.55 |
| Viscosity (Pa · s) | 10.6 | 10.8 | 16.5 | 13.2 | 14.4 |
| Shelf Stability (%) | 14 | 18 | 23 | Cured | Cured |
| Shore D Hardness | 28 | 18 | 25 | Non-cured | Non-cured |
| Cure Rate (%) | 93.8 | 92.8 | 65.5 | 42.0 | 65.7 |
| Gel-time After UV exposure, | Cured | Cured | Semi- | Semi-cured | Semi-cured |
| Product state after 4 hrs. | | | cured | without UV | without UV |
| Gel-time After UV exposure, | 81 | 93 | 57 | N/A | N/A |
| Cure Rate after 4 hrs. (%) | | | | | |

According to Practical Examples 1 to 4, high phenyl contained curable silicone compositions had long gel time after UV irradiation as Si—H reaction rate was less than 50% in 4 hrs. and maintained gel state. Post-cure speed was also significantly fast at low temperature, as cure rates were over 94% in 30 mins. It was observed that phenyl contents over 26% had prominent effects for those properties. Hardness increase was followed by using higher phenyl contents.

According to Comparative Examples 1 to 3, reducing phenyl contents had characteristics that gel-time was much faster and reached all most full cure in 4 hrs. after UV irradiation. Moreover, viscosity increases were over 10%. For methyl system (Comparative Example 3), it was observed that cure profile had some limitations at lower temperatures, however, methyl composition was fully cured at high temperature >100° C.

According to Comparative Examples 4 and 5, hydrosilylation (heat cure) had poor pot-life and not fully cured at low temperature (<75° C.) even with high phenyl content silicone compositions. All samples were cured by LED UV (Firejet FJ800) equipment with 365 nm and energy 5,000 mJ/cm² dosage of UVA.

### INDUSTRIAL APPLICABILITY

The UV curable silicone composition of the present invention has a good pot-life in a form of 1-part composition, and cures to form a B-stage material by irradiating with an ultraviolet light, wherein the B-stage material exhibits a slow gel-time, however, can fully cure at a low temperature, e.g., 75° C. or below. Therefore, the composition is useful for sealants, adhesives, or coatings of an optical semiconductor element in electric/electronic apparatus.

1. A UV curable silicone composition comprising:
(A) a branched organopolysiloxane having at least one alkenyl group with 2 to 12 carbon atoms and at least one aryl group with 6 to 12 carbon atoms per molecule;
(B) a linear organopolysiloxane having at least two alkenyl groups with 2 to 12 carbon atoms and at least one aryl group with 6 to 12 carbon atoms per molecule;
(C) an organosiloxane having at least two silicon-bonded hydrogen atoms and at least one aryl group with 6 to 12 carbon atoms per molecule, in an amount such that silicon-bonded hydrogen atoms in component (C) is 0.1 to 10 moles relative to 1 mole of alkenyl groups in components (A) and (B); and
(D) a catalytic amount of a photoactivated hydrosilylation reaction catalyst;
wherein a content of total aryl groups in components (A) to (C) is at least 35 mass % of a total mass of components (A) to (C).

2. The UV curable silicone composition according to claim 1, wherein component (A) is a branched organopolysiloxane represented by the following average unit formula: 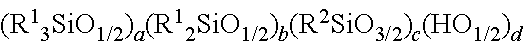
wherein each R¹ is independently an alkyl group with 1 to 12 carbon atoms, alkenyl group with 2 to 12 carbon atoms, or an aryl group with 6 to 12 carbon atoms, with the proviso that at least one R¹ in a molecule being an alkenyl group; R² is an alkyl group with 1 to 12 carbon atoms or an aryl group with 6 to 12 carbon atoms, with the proviso that at least one R² in a molecule being an aryl group; and “a”, “b”, “c” and “d” are numbers satisfying the following conditions: 0<a≤0.3, 0≤b≤0.2, 0.5≤c≤0.9, 0≤d≤0.05, and a+b+c=1.

3. The UV curable silicone composition according to claim 1, wherein component (B) is a linear organopolysiloxane represented by the following general formula: 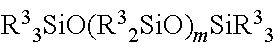
wherein each R³ is independently an alkyl group with 1 to 12 carbon atoms, alkenyl group with 2 to 12 carbon atoms, or an aryl group with 6 to 12 carbon atoms, with the proviso that at least two R³ in a molecule being alkenyl groups and at least one R³ in a molecule being an aryl group; and “m” is an integer of from 10 to 1,000.

4. The UV curable silicone composition according to claim 1, wherein component (C) is an organosiloxane represented by the following general formula: 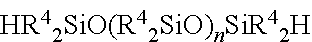
wherein each R⁴ is independently an alkyl group or an aryl group, with the proviso that at least one R⁴ is an aryl group; and “n” is an integer of 0 to 10.

5. The UV curable silicone composition according to claim 1, further comprising:
(E) a hydrosilylation reaction inhibitor, in an amount of 0.1 to 10,000 ppm in this component in terms of mass units with respect to a total mass of components (A) to (C).

6. The UV curable silicone composition according to claim 1, further comprising:
(F) an adhesion promotor, in an amount of at most 10 parts by mass relative to 100 parts by mass of a total mass of components (A) to (C).

7. The UV curable silicone composition according to claim 1, further comprising:
(G) a silica filler, in an amount of 0.1 to 10 parts by mass relative to 100 parts by mass of a total mass of components (A) to (C).

8. The UV curable silicone composition according to claim 5, further comprising:
(F) an adhesion promotor, in an amount of at most 10 parts by mass relative to 100 parts by mass of a total mass of components (A) to (C).

9. The UV curable silicone composition according to claim 8, further comprising:
(G) a silica filler, in an amount of 0.1 to 10 parts by mass relative to 100 parts by mass of a total mass of components (A) to (C).

10. The UV curable silicone composition according to claim 5, further comprising:
(G) a silica filler, in an amount of 0.1 to 10 parts by mass relative to 100 parts by mass of a total mass of components (A) to (C).

11. The UV curable silicone composition according to claim 6, further comprising:
(G) a silica filler, in an amount of 0.1 to 10 parts by mass relative to 100 parts by mass of a total mass of components (A) to (C).
